(19) United States
(12) Patent Application Publication
(10) Pub. No.: US 2016/0348755 A1
(43) Pub. Date: Dec. 1, 2016

(54) ARTICULATED CHAIN WITH EXPANSION-TYPE OUTER LINK PLATE

(71) Applicant: IWIS MOTORSYSTEME GmbH & Co. KG, Munchen (DE)

(72) Inventors: Andreas RITZ, Munchen (DE); Erwin FELD, Riemerling (DE); Karim ELWAN, Munchen (DE)

(21) Appl. No.: 14/796,931

(22) Filed: Jul. 10, 2015

(30) Foreign Application Priority Data
May 29, 2015 (DE) 202015003932.4

(51) Int. Cl. F16G 13/06; F16H 7/06; F16H 7/08; F16G 13/04

(52) U.S. Cl. CPC F16G 13/06; F16G 13/04; F16H 7/06; F16H 7/08

(57) ABSTRACT

An articulated chain includes alternate outer chain links and inner chain links interconnected by respective chain joints. The outer chain links comprise two outer link plates that are spaced apart in parallel, the outer link plates having two pin holes, which are spaced apart in the link-plate longitudinal direction and which each have fixedly arranged therein a respective joint pin of the chain joints. The inner chain links comprise two inner link plates that are spaced apart in parallel, and the joint pin being pivotably arranged in a joint opening of the inner chain links. The outer link plates comprise at least one expansion opening between the pin holes in order to reduce the bending of the joint pin and the surface pressure in the joint opening of the inner chain links, so as to improve the sliding behavior and the wear properties of the chain joints.

### CROSS-REFERENCE TO RELATED APPLICATION

This application claims priority to foreign German patent application No. DE 202015003932.4, filed on May 29, 2015, the disclosure of which is incorporated by reference in its entirety.

### FIELD OF THE INVENTION

The present invention relates to an articulated chain with alternate outer chain links and inner chain links interconnected by respective chain joints, said outer chain links comprising two outer link plates that are spaced apart in parallel, said outer link plates having two pin holes, which are spaced apart in the link-plate longitudinal direction and which each have fixedly arranged therein a respective joint pin of the chain joints, said inner chain links comprising two inner link plates that are spaced apart in parallel, and said joint pin being pivotably arranged in a joint opening of the inner chain links.

### BACKGROUND

Articulated chains with inner chain links comprising two inner link plates and two joint bushings, positioning the inner link plates in spaced relationship with one another, are often used as roller chains or bush chains in internal combustion engines. When comparatively high forces are to be transmitted, a plurality of link plates are arranged in parallel in the outer and inner chain links of articulated chains, such link chains being used especially in the form of toothed chains or leaf chains in internal combustion engines.

Conventional link chains consist of alternate outer chain links and inner chain links, the outer chain link comprising two outer link plates and at least one central link plate arranged between the outer link plates on the joint pins. For connecting the outer and inner chain links, at least one respective inner link plate of the inner chain link is pivotably arranged on the joint pin between the outer link plates and the at least one central link plate.

When link chains are used in timing chain drives of internal combustion engines, the inner link plates and normally also the central link plates are configured as toothed plates, whereas the outer link plates serve as guide link plates. Whereas the inner link plates of the inner chain links are pivotably arranged on the joint pin, said inner link plates being provided individually or as packages, the outer link plates of the outer chain links are normally fixedly positioned on the joint pins of the chain joints.

By fixing the outer link plates and the central link plates on the joint pin of the chain joints by means of a press fit, a wide-bearing chain joint, which is supported by the central link plates and which exhibits a comparatively uniform load distribution, is obtained. During assembly of these link chains, the joint pins, which are, in principle, arranged in parallel, are pushed into a position where they are not parallel to one another, when the first outer link plate and at least one central link plate have been pressed on. Even slight differences in the spacings of the outer link plate and the central link plate, which lie within the range of conventional manufacturing tolerances, will already suffice to cause the joint pins to assume a skewed position relative to one another. This skewed position makes it much more difficult to mount the second outer link plate and increases thus the manufacturing costs and the reject rate. The use of hardened joint pins, which is common practice in the case of modern link chains, increases the mounting problems caused by a skewed position of the joint pins relative to one another. It is true that these difficulties can be reduced through smaller tolerances for the spacing of the link plate openings, but, due to the normally used method of manufacturing chain link plates by means of punching and shaving, such optimizations are only possible to a very limited extent and cause high tool costs.

A possibility, which is known from the prior art and which allows to prevent a skewed position of the joint pins during mounting and the resultant mounting problems, is to enlarge the diameter of the pin holes of the central link plates and to arrange the central link plates in a sliding fit on the joint pin. The increased amount of tolerance between the central link plates relative to the outer link plates press-fitted onto the joint pins avoids, after the mounting of the central link plates, a skewed position of the joint pins. Unfortunately, the increased amount of tolerance and the larger diameter of the pin holes of the central link plates allow not only easier mounting of the outer link plates during the manufacturing phase, but they also cause uneven loads on the outer and central link plates of the outer chain link during operation. When a load is applied to the link chains, the central link plates take up either no or only a very small amount of said load. In addition to the uneven loads applied to the outer and central link plates, this also results in increased bending of the pin, whereby more wear will occur at the inner link plates as a result of so-called edge bearers. Due to the bending of the joint pins, the area of the articular surfaces of the inner link plates adjoining the outer link plates will be subject to a higher surface pressure, which causes more wear at the joint pin or at the articular surface of the inner link plates. In the case of high loads or an increase in wear, the bearing will then be done only by the edges of the articular surfaces.

Reference DE 10 2009 052 211 A1 discloses a link chain with minimized joint pin bending, in the case of which the outer and central link plates of an outer chain link of a link chain are arranged alternately in a loose sliding fit or a press fit on the joint pins of the chain joints. Although bending of the joint pins can be reduced in this way, the directed assembly of the outer and central link plates during mounting of the link chains requires a high manufacturing effort. In addition, the load-carrying capacity and the service life of this link chain is reduced due to the reduced number and the alternate arrangement of the press fits.

The various problems of the prior art articulated chains during mounting and operation resulted in different structural designs for solving the problems in question, e.g. the use of hardened chain pins, the reduction of manufacturing tolerances or the variation of press fits, without being able to fully eliminate the respective drawbacks or to avoid new drawbacks. Hence, it is the object of the present invention to provide an articulated chain, which is easy to mount, and to provide good stability and wear characteristics.

### SUMMARY OF THE INVENTION

In the case of an articulated chain of the generic kind, the above object is achieved according to the present invention in that the outer link plates exhibit at least one expansion opening between the pin holes. This kind of structural design of the outer chain link plate allows an increased expandability of the outer link plate through the weakening of said outer link plate between the pin holes. This has the effect that, when a load is applied to the articulated chain during operation, the outer link plate will be expanded more strongly, whereas the joint pin will be bent less strongly. Due to the reduced bending of the joint pin, the latter can be in better full-area contact with the articular surfaces of the inner link plates, whereby the resultant surface pressure will be reduced. The reduced surface pressure in the joint opening of the inner chain links leads, in total, to a substantially improved sliding behavior and to reduced wear. Also during mounting of the outer chain links, the increased expandability of the outer chain links allows the skewed position of the joint pins to be reduced or easily compensated for, and thus easier mounting of the outer link plates.

For accomplishing a good uniform distribution of stress in the outer link plate when the articulated chain operates under load, the expansion opening may be elongate in shape, a longitudinal axis of the expansion opening extending substantially perpendicular to the link-plate longitudinal direction especially in the case of narrow outer link plates.

According to an advantageous embodiment, the expansion opening has rounded corners and a shape that is convex in the link-plate longitudinal direction. The rounded corners and the convex shape of the expansion opening guarantee that the stress can distribute as freely as possible in the outer link plate around the expansion opening. For an optimum structural design of the expansion opening with respect to the distribution of stress in the outer link plate as well as with respect to mass reduction of the articulated chain, the maximum height of the expansion opening may be between 10% and 50%, preferably between 20% and 40%, of the maximum width of the outer link plate. The width of the expansion opening may be between 70% and 110% of the maximum height of the expansion opening. The convex shape of the expansion opening in the link-plate longitudinal direction may have a radius of 0.2 to 0.4 of the pitch of the outer link plate.

According to a preferred embodiment, the expansion opening and the pin holes have formed between them a respective residual web and the residual webs have a width which is between 40% and 90%, preferably between 50% and 80%, of the distance between the pin hole and the outer contour on the end face side of the outer link plates. In spite of the increased expandability of the outer link plate, this embodiment allows good strength characteristics, especially for the pin holes, in combination with an adequate operational reliability for operating the articulated chain.

According to a preferred embodiment, the joint pins of the chain joints may be configured as round pins, preferably as hardened round pins. The use of round pins in the chain joints of articulated chains results in a simple chain structure without any anti-backbend function. Making use of hardened round pins, e.g. hardened, quenched and tempered or short-time gas-nitrided joint pins with or without a coating of chromium carbide, vanadium carbide or chromium nitride, the bending and the wear of joint pins can be reduced and, in combination with the increased expandability of the outer link plates, it is thus possible to achieve a uniform surface pressure in the articular surfaces and, consequently, minimum wear.

For manufacturing a load-resistant articulated chain with high strength in combination with little wear, at least one central link plate may be provided and the articulated chain may be configured as a link chain. For reliable engagement between the link chain and sprockets associated therewith, the at least one central link plate of the outer chain link and/or the inner link plates of the inner chain links may be configured as toothed plates. Alternatively, the inner chain links may comprise two joint bushings with joint openings so as to arrange the two inner link plates in parallel spaced relationship with one another. Such an articulated chain, which is configured as a bush chain or a roller chain, can be produced at a reasonable price and used for a great variety of applications.

For easy mounting and for avoiding a skewed position of the joint pins, the at least one central link plate of the outer chain links may be arranged on the joint pins in a loose fit. This also allows a production of the components of the link chain with higher tolerances.

According to another embodiment, the outer link plates of the outer chain links have a symmetric outer contour, preferably an outer contour which is mirror-inverted in the link-plate longitudinal direction. A symmetric and/or mirror-inverted outer contour allows the outer link plates to be incorporated in different feed directions, when the articulated chain is being mounted, and facilitates thus the sorting and the directed feed during the manufacturing process.

In addition, the present invention relates to a chain drive for an internal combustion engine, comprising a driving sprocket, at least one driven sprocket, an articulated chain according to one of the above-described embodiments, which connects the driving sprocket and the at least one driven sprocket, and a tensioning device which tensions the articulated chain. By means of the special structural design of the articulated chain with outer link plates having at least one expansion opening between the pin holes, edge bearers can be avoided when a load is applied to the articulated chain during operation, and, consequently, the total amount of wear can be reduced and the service life of the articulated chain can be extended.

### BRIEF DESCRIPTION OF THE DRAWINGS

In the following, the present invention will be explained in more detail making reference to the drawings, in which:

FIG. 1 shows a chain drive for an internal combustion engine according to the present invention,

FIG. 2 shows a top view of a link chain according to the present invention,

FIG. 3 shows a side view of the link chain according to FIG. 2, configured as a silent chain,

FIG. 4 shows a side view of the link chain according to FIG. 2, configured as a leaf chain,

FIG. 5a shows an enlarged side view of the outer link plate according to FIGS. 3 and 4,

FIG. 5b shows a side view of an alternative embodiment of an outer link plate of a link chain according to the present invention,

FIG. 6a shows a section through an unloaded chain joint of a link chain according to the prior art,

FIG. 6b shows a section through a loaded chain joint of a link chain according to the prior art,

FIG. 7a shows a section through an unloaded chain joint of a link chain according to the present invention, and

FIG. 7b shows a section through a loaded chain joint of a link chain according to the present invention.

### DETAILED DESCRIPTION

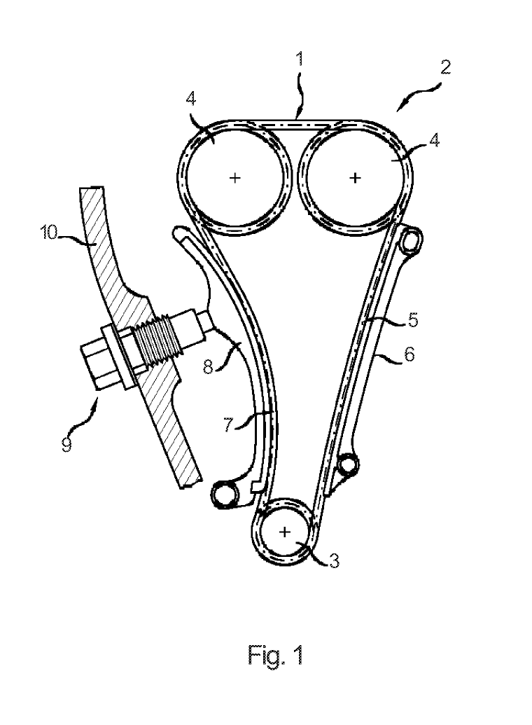

FIG. 1 shows the use of an articulated chain according to the present invention, e.g. of a plate link chain 1 in a chain drive 2 of an internal combustion engine. This chain drive 2 may be a timing chain drive of an internal combustion engine, comprising a lower crankshaft sprocket 3 and two upper juxtaposed camshaft sprockets 4. The link chain 1 is flexibly wrapped around the camshaft sprockets 4 and the crankshaft sprocket 3 and connects them to one another. In the tight span 5 of the chain drive 2 a guide rail 6 is arranged, along which the link chain 1 slides. The oppositely disposed slack span 7 of the chain drive 2 has provided thereon a tensioning rail 8, which is pivotably supported in the vicinity of the crankshaft sprocket 3 and which is adapted to be pressed against the link chain 1 by means of a tensioning device 9 so as to provide a pretension to the slack span 7 of the chain drive 2. In the present embodiment according to FIG. 1, the tensioning device 9 is configured as a screw-in chain tensioner, which is screwed into a component of the engine block 10 and which presses with its tensioning piston onto a press-on area of the tensioning rail 8, said tensioning rail 8 being thus pressed against the link chain 1 with a predetermined force. Alternatively, the tensioning device 9 may also be configured as a flange-type tensioner, which is flanged onto the engine block 10 via separate fastening means.

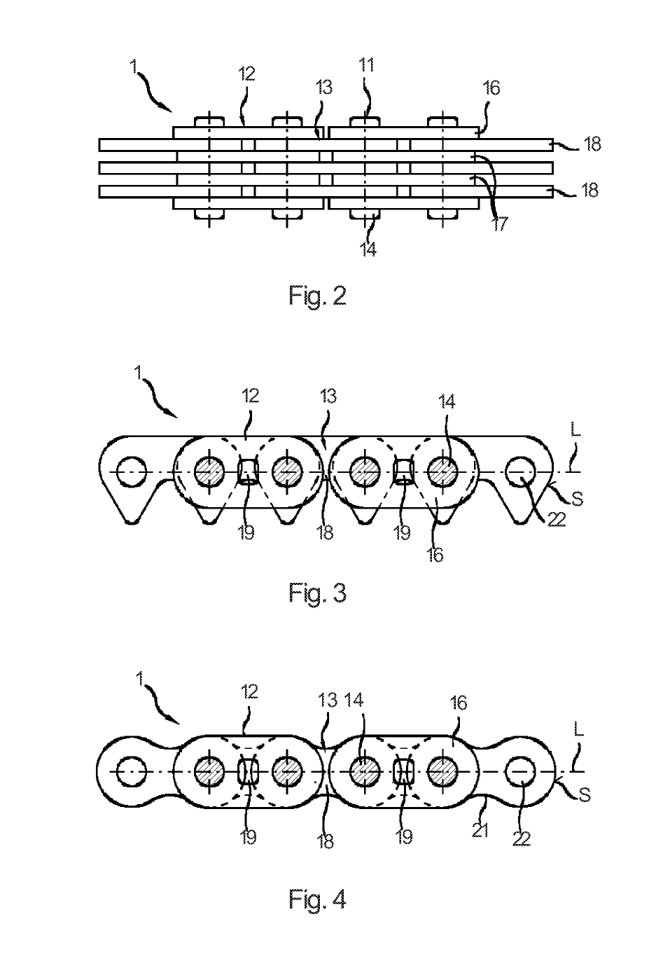

FIG. 2 shows a top view of a link chain 1 according to the present invention with alternate outer chain links 12 and inner chain links 13 interconnected by a respective chain joint 11. The outer chain links 12 comprise two lateral outer link plates 16 arranged in spaced-apart parallel relationship with one another and two inner central link plates 17 as well as two joint pins 14 of the associated chain joints 11, which extend through the outer link plates 16 and the central link plates 17. The inner chain links 13 each comprise three separately arranged inner link plates 18, said inner link plates 18 being pivotably arranged on the joint pins 14 between the outer link plates 16 and the central link plates 17 so as to interconnect the adjoining outer chain links 12. Alternatively, the inner link plates 18 of the inner chain links 13 as well as the central link plates 17 of the outer chain links 12 may be configured as link plate packages comprising each at least two inner link plates 18 or central link plates 17.

FIG. 3 shows a link chain 1 according to the present invention in an embodiment configured as a silent chain. The central link plates 17 of the outer chain link 12 and the inner link plates 18 of the inner chain link 13 are here configured as toothed plates, whereas the outer link plates 16 according to the embodiment shown are configured as guide link plates without projecting teeth and without any recess for engagement with the teeth of an associated sprocket. The outer link plates 16 have an elongate expansion opening 19 between the joint pins 14 protruding from the pin holes 15 of the outer link plates 16, said expansion opening 19 allowing a higher expandability of the outer link plates 16 in comparison with the central link plates 17 of the outer chain links 12 when the link chain 1 operates under load.

Furthermore, FIG. 4 shows a link chain 1 configured as a leaf chain, in which the outer link plates 16 and the central link plates 17 of the outer chain link 12 as well as the inner link plates 18 of the inner chain link 13 are configured as substantially straight chain link plates without teeth projecting on one side and without recesses for engagement of an associated sprocket. In the embodiment shown, the outer link plates 16 are formed as straight link plates, whereas the central link plates 17 and the inner link plates 18 are waisted, the two backs 20 of the central link plates 17 and of the inner link plates 18 exhibiting, in the link-plate longitudinal direction L, a waist 21 in the form of concave recesses. Also in this case, the outer link plates 16 are provided with an elongate expansion opening 19 between the pin holes 15, said expansion opening 19 extending perpendicular to the link-plate longitudinal direction L.

Irrespectively of whether the link chain 1 is configured as a silent chain or as a leaf chain, the central link plates 17 of the outer chain links 12 and the inner link plates 18 of the inner chain links 13 of a link chain 1 according to the present invention each have two joint openings 22, which are arranged in spaced relationship with each other on a central axis in the link-plate longitudinal direction L and which are associated with the respective end faces S of the central link plates 17 and of the inner link plates 18. The joint pins 14 of the chain joints 11 extend through the respective joint openings 22 of the central link plates 17 and inner link plates 18 arranged between the external outer link plates 16, said joint openings 22 being arranged on the joint pins 14 in a clearance fit so that a pivotable connection is formed between the outer chain links 12 and the inner chain links 13.

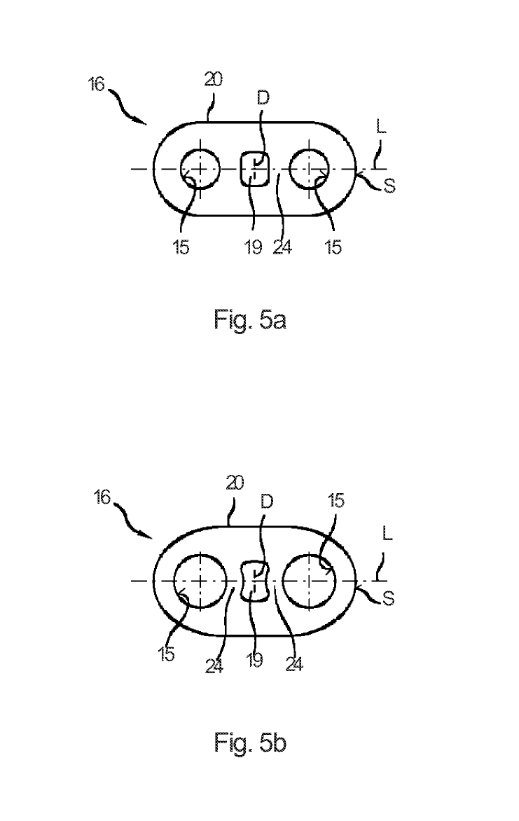

In the side view of the outer link plate 16 of a link chain 1 according to the present invention shown in FIG. 5a, the arrangement of the pin hole 15 along the link-plate longitudinal direction L can be seen, said pin hole 15 facing the end face S. Between the pin holes 15, the expansion opening 19 is provided at the center of the outer link plates 16. The elongate expansion opening 19 arranged centrally between the pin holes 15 has an expansion opening axis D, which extends substantially perpendicular to the link-plate longitudinal direction L. The expansion opening 19 has rounded corners and two convex sides extending in the link-plate longitudinal direction so as to prevent a negative influence on the distribution of stress in the outer link plate 16 along the back 20.

FIG. 5b shows a side view of a further outer link plate 16 including an expansion opening 19 for a link chain 1 according to the present invention. In the case of this outer link plate 16, the pin holes 15, in which the joint pins 14 are press-fitted during mounting of the link chain, are configured with a larger diameter. In addition, this embodiment of the outer link plate 16 has a back 20 spaced at a larger distance from the link-plate longitudinal direction L. The expansion opening 19 is slightly waisted, in addition to the rounded corners and the convex sides, so as to allow, with respect to the large diameter of the pin holes 15, a sufficiently broad residual web 24 between the expansion opening 19 and the pin holes 15, thus guaranteeing adequate strength characteristics of the outer link plate 16.

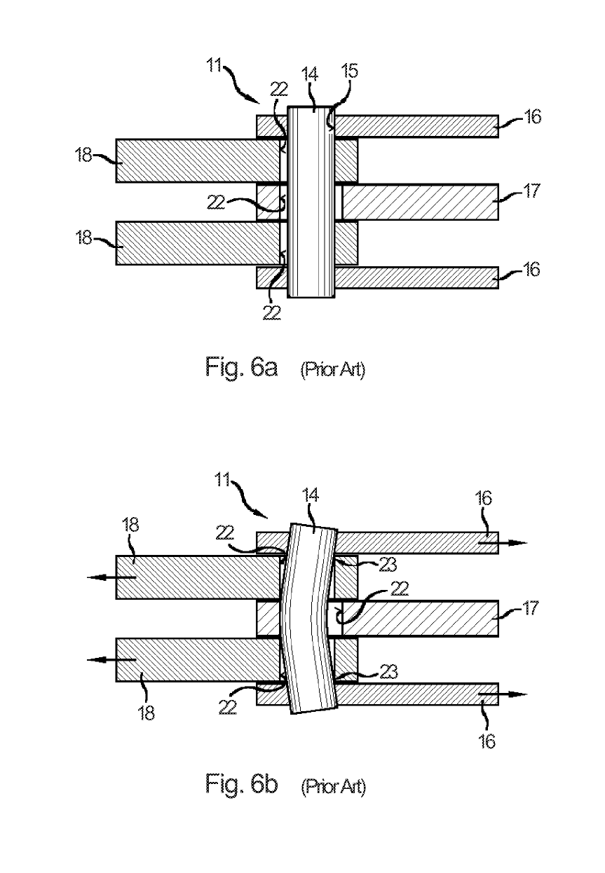

FIG. 6a shows a section through a chain joint 11 of a link chain according to the prior art. The central link plates 17 of the outer chain link 12 and the inner link plates 18 of the inner chain link 13 are arranged, via the joint openings 22, on the joint pin 14 in a loose sliding fit. The outer link plates 16 of the outer chain link 12 are fixedly arranged on the joint pin 14 in a press fit via the pin holes 15. As can be seen in FIG. 6b, applying a load to this chain joint 11 during operation of the prior art link chain results in bending of the joint pin 14. The load acting between the outer link plates 16 of the outer chain link 12 and the inner link plates 18 of the inner chain link 13, indicated by arrows in FIG. 6b, results in an area of increased load, a so-called edge bearer 23, on the outer side of the inner link plates 18 which faces the outer link plate 16, since, due to the fact that the joint pin 14 bends, the area of the joint opening 22 utilized as an articular surface will be reduced, whereby the surface pressure will increase in this area. Hence, increased wear will occur at the edge bearers 23 in the area of the joint opening 22 and of the joint pin 14.

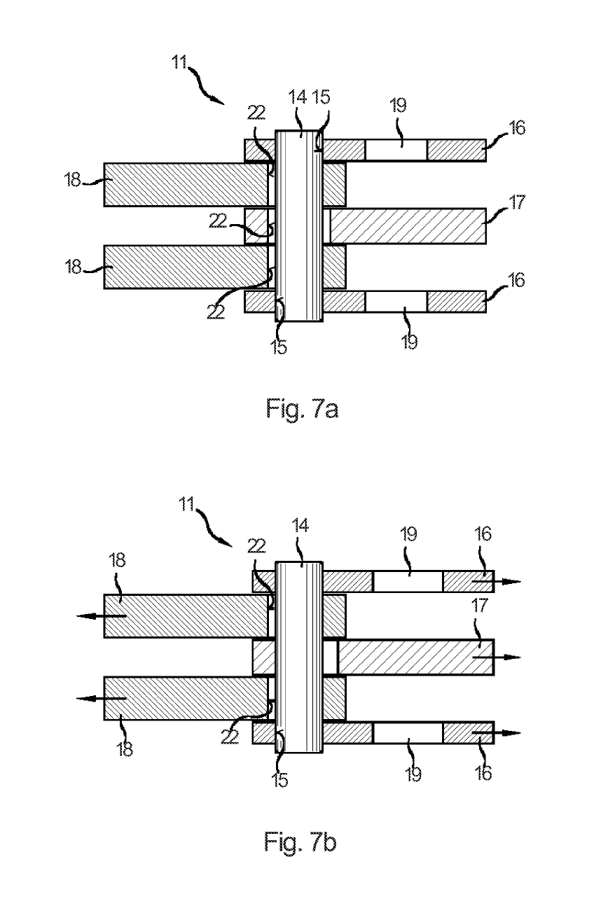

Furthermore, FIG. 7a shows the chain joint 11 of a link chain 1 according to the present invention. Also in this case, the central link plates 17 of the outer chain link 12 and the inner link plates 18 of the inner chain link 13 are arranged, via their joint openings 22, on the joint pin 14 in a sliding fit, whereas the outer link plates 16 of the outer chain link 12 are fixedly positioned on the joint pin 14 in a press fit via the pin holes 15, and secure the chain joint 11 in position. This sectional view of the chain joint 11 of a link chain 1 according to the present invention additionally shows the expansion opening 19 in the outer link plates 16. When a load is applied to this chain joint during operation of the link chain, the joint pin 14 will not be bent, as can be seen in FIG. 7b, in spite of the load, again indicated by the arrows, acting between the outer link plates 16 and the inner link plates 18, since the outer link plates 16 of the outer chain link 12 expand through the expansion opening 19 in the link-plate longitudinal direction L until also the central link plate 17 of the outer chain link 12 will transmit part of the load acting on the chain joint 11.

### LIST OF REFERENCE NUMERALS

1 link chain
2 chain drive
3 crankshaft sprocket
4 camshaft sprocket
5 tight span
6 guide rail
7 slack span
8 tensioning rail
9 tensioning device
10 engine block
11 chain joint
12 outer chain link
13 inner chain link
14 joint pin
15 pin holes
16 outer link plate
17 central link plate
18 inner link plate
19 expansion opening
20 back
21 waist
22 joint opening
23 edge bearer
24 residual web
L link-plate longitudinal direction
S end face
D expansion opening axis

1. An articulated chain with alternate outer chain links and inner chain links interconnected by respective chain joints, having joint pins,
said inner chain links comprising two inner link plates that are spaced apart in parallel, and said inner link plates being arranged in a loose fit on the joint pins,
said outer chain links comprising two outer link plates that are spaced apart in parallel, said outer link plates having two pin holes, which are spaced apart in the link-plate longitudinal direction and which each have fixedly arranged therein a respective joint pin of the chain joints, wherein the outer link plates comprising at least one expansion opening positioned between the pin holes.

2. The articulated chain according to claim 1, wherein the expansion opening is elongate in shape.

3. The articulated chain according to claim 2, wherein a longitudinal axis of the expansion opening extends substantially perpendicular to the link-plate longitudinal direction .

4. The articulated chain according to claim 2, wherein the expansion opening has rounded corners and a shape that is convex in the link-plate longitudinal direction.

5. The articulated chain according to claim 1, wherein the expansion opening and the pin holes have formed between them a respective residual web and that the residual webs have a width which is between 40% and 90% of the distance between the pin hole and the outer contour on the end face side of the outer link plates.

6. The articulated chain according to claim 5, wherein the width is between 50% and 80%, of the distance between the pin hole and the outer contour of the end face of the outer link plates.

7. The articulated chain according to claim 1, wherein the outer link plates of the outer chain links have a symmetric outer contour.

8. The articulated chain according to claim 7, wherein the outer link plates of the outer chain links have an outer contour which is mirror-inverted in the link-plate longitudinal direction.

9. The articulated chain according to claim 1, wherein the joint pins are configured as round pins.

10. The articulated chain according to claim 9, wherein the round pins are hardened round pins.

11. The articulated chain according to claim 1, wherein at least one central link plate is provided, which is arranged between the outer link plates of the outer chain links, and that the articulated chain is configured as a link chain.

12. The articulated chain according to claim 11, wherein at least one of the at least one central link plate and the inner link plates of the inner chain links are configured as toothed plates.

13. The articulated chain according to claim 11, wherein the at least one central link plate of the outer chain links is arranged on the joint pin in a loose fit.

14. The articulated chain according to claim 1, wherein the inner chain links comprise two joint bushings, which arrange the inner link plates in parallel spaced relationship with one another, said joint bushings defining the joint openings of the inner chain links and the articulated chain being configured as a bush chain or a roller chain.

15. A chain drive for an internal combustion engine, comprising a driving sprocket, at least one driven sprocket, an articulated chain, which interconnects the driving sprocket and the at least one driven sprocket, and a tensioning device which tensions the articulated chain, wherein the articulated chain having alternate outer chain links and inner chain links interconnected by respective chain joints having joint pins,
said inner chain links comprising two inner link plates that are spaced apart in parallel, and said inner link plates being arranged in a loose fit on the joint pins,
said outer chain links comprising two outer link plates that are spaced apart in parallel, said outer link plates having two pin holes, which are spaced apart in the link-plate longitudinal direction and which each have fixedly arranged therein a respective joint pin of the chain joints, wherein the outer link plates comprising at least one expansion opening positioned between the pin holes.
